(19) United States
(12) Patent Application Publication
(10) Pub. No.: US 2003/0108459 A1
(43) Pub. Date: Jun. 12, 2003

(54) Nano powder production system

(76) Inventors: L. W. Wu, Auburn, AL (US); Wen-Chiang Huang, Auburn, AL (US)

Correspondence Address: Wen-Chiang Huang, 2076, S. Evergreen Dr., Auburn, AL, 36830, US

(21) Appl. No.: 10/006,378

(22) Filed: Dec. 10, 2001

(51) Int. Cl. B01J 19/08

(52) U.S. Cl. 422/186.04; 422/186.29

(57) ABSTRACT

A system for synthesizing a nano-scaled powder material, including several sub-systems: (A) a chamber for containing nano-scaled cluster generating devices from a material selected from the group consisting of a metal, a metal compound, and a ceramic; (B) a twin-wire electrode device disposed within this chamber with this electrode device including: (i) two wires made up of this material, each having a leading tip and each being continuously or intermittently fed into the chamber in such a fashion that the two leading tips are maintained at a desired separation; and (ii) power supply for providing electric current and gas supply for providing a working gas flow for creating an ionized arc between the two leading tips for melting and/or vaporizing the material to generate nano-scaled clusters; (C) devices for injecting a quench gas and/or a reaction gas into a quenching/reaction zone inside the chamber at a point downstream from the arc to produce nano-scaled powder particles; and (D) devices such as a cyclone and powder classifier to collect the nano-scaled powder material.

The present invention was based on the research results of a project supported by the U.S. National Science Foundation SBIR Program. The U.S. Government has certain rights on this patent.

### FIELD OF THE INVENTION

The present invention relates to a system for producing ultra fine metal, metal compound, and ceramic particles. More particularly, it relates to a system for producing nanometer-sized metal, metal compound, and ceramic particles at a high production rate using a twin-wire arc based material feeding, heating and vaporizing device along with a quenching/reactive gas supply.

### BACKGROUND

Nanometer-sized particles (d<200 nm) of metals, semiconductors and ceramics exhibit unique processing characteristics as well as performance properties. The novel properties of nano-crystalline materials are due to their small residual pore sizes (small intrinsic defect sizes), limited grain, phase or domain dimensions, unique Bohr radius, and large fraction of atoms residing in interfaces. Specifically, ceramics fabricated from ultra-fine particles are known to possess high strength and toughness because of the ultra-small intrinsic defect sizes and the ability for grain boundaries to undergo a large plastic deformation. In a multi-phase material, limited phase dimensions could imply a limited crack propagation path if the brittle phase is surrounded by ductile phases so the cracks in a brittle phase would not easily reach a critical crack size. In addition, dislocation movement distances in a metal could be limited in ultra fine metallic domains, leading to unusually high strength and hardness. Even with only one constituent phase, nano-crystalline materials may be considered as two-phase materials, composed of distinct interface and crystalline phases. Further, the possibilities for reacting, coating, and mixing various types of nano materials create the potential for fabricating new composites with nanometer-sized phases and novel properties. Commercial applications of nano particles have included health care/cosmetics, chemical catalysts, microelectronic devices, polishing slurries, light-emitting devices, structural ceramics, and biomedical devices.

The techniques for the generation of nanometer-sized particles may be divided into three broad categories: vacuum, gas-phase, and condensed-phase synthesis. Vacuum synthesis techniques include sputtering, laser ablation, and liquid-metal ion sources. Gas-phase synthesis includes inert gas condensation, oven sources (for direct evaporation into a gas to produce an aerosol or smoke of clusters), laser-induced vaporization, electron beam-induced vaporization, laser pyrolysis, aerosol decomposition and flame hydrolysis. Condensed-phase synthesis includes reduction of metal ions in an acidic aqueous solution, liquid phase precipitation of semiconductor clusters, and decomposition-precipitation of ionic materials for ceramic clusters. Other methods include high-energy milling, mix-alloy processing, chemical vapor deposition (CVD), and sol-gel techniques.

All of these techniques have one or more of the following problems or shortcomings:

(1) Most of these prior-art techniques suffer from a severe drawback: extremely low production rates. It is not unusual to find a production rate of several grams a day. Vacuum sputtering, for instance, only produces small amounts of particles at a time. Laser ablation and laser-assisted chemical vapor deposition techniques are well-known to be excessively slow processes. The high-energy ball milling method, known to be a “quantity” process, is capable of producing only several kilograms of nano-scaled powders in approximately 100 hours. These low production rates, resulting in high product costs, have severely limited the utility value of nano-phase materials. There is, therefore, a clear need for a faster, more cost-effective method for preparing nanometer-sized powder materials.

(2) Condensed-phase synthesis such as direct reaction of metallic silicon with nitrogen to produce silicon nitride powder requires pre-production of metallic silicon of high purity in finely powdered form. This reaction tends to produce a silicon nitride powder product which is constituted of a broad particle size distribution. Furthermore, this particular reaction does not yield a product powder finer than 100 nm (nanometers) except with great difficulty. Due to the limited availability of pure metallic silicon in finely powdered form, the use of an impure metallic powder necessarily leads to an impure ceramic product. These shortcomings are true of essentially all metallic elements, not just silicon.

(3) Some processes require expensive precursor materials to ceramic powders and could result in harmful gas that has to be properly disposed of. For instance, the reaction scheme of 3SiCl₄+4NH₃=Si₃N₄+12HCl involves the utilization of expensive SiCl₄ and produces dangerous HCl gas. As one example, Pratsinis, et al. (U.S. Pat. No. 5,698,177, Dec. 16, 1997) used a flame reactor to convert TiCl₄ and oxygen into TiO₂.

(4) Most of the prior-art processes are capable of producing a particular type of ceramic powder at a time, but do not permit the preparation of a uniform mixture of two or more types of nano-scaled ceramic powders at a predetermined proportion.

(5) Most of the prior-art processes require heavy and/or expensive equipment (e.g., a high power laser source or a plasma generator), resulting in high production costs. For instance, Eastman, et al. (U.S. Pat. No. 5,728,195, Mar. 17, 1998) used an electron beam source to vaporize metallic elements. In the precipitation of ultra fine particles from the vapor phase, when using thermal plasmas or laser beams as energy sources, the particle sizes and size distribution cannot be precisely controlled. Also, the reaction conditions usually lead to a broad particle size distribution as well as the appearance of individual particles having diameters that are multiples of the average particle size.

(6) The conventional mechanical attrition and grinding processes have the disadvantages that powders can only be produced up to a certain fineness and with relatively broad particle-size distribution. As a matter of fact, with the currently familiar large-scale process for manufacturing powders it is rarely possible, or only possible with considerable difficulty, to produce powders having average particle sizes of less than 0.5 μm (microns).

(7) Aerosol processes provide the advantages of small particle size, narrow size distribution, nearly spherical particles and high purity. Aerosol processes also are energy efficient and avoid the treatment of large liquid volumes associated with traditional wet chemistry processes. However, conventional aerosol processes are very complex and involve many physicochemical phenomena and mechanisms, such as chemical reaction, particle nucleation, condensation, coagulation, aggregation, heat and mass transfer, and thermophoresis. The fundamentals of these processes are not well understood and, consequently, the processes are difficult to control precisely. This makes design, operation and control of industrial reactors to carry out these processes more of an art than a science, relying heavily on experience and empiricism. The most serious problem associated with aerosol decomposition is the formation of impurities from the precursor chemical species (e.g., SiCl₄, NH₃, TiCl₄, etc.). The final impure products cannot be used in health care or cosmetics markets, for instance. Processes that involve decomposition of a precursor material are disclosed in the following U.S. patents: U.S. Pat. Nos. 4,994,107 (Feb. 19, 1991 to Flagan, et al.), 5,075,090 (Dec. 24, 1991 to Lewis, et al.), 4,891,339 (Jan. 2, 1990 to Calcote, et al.), 5,368,825 (Nov. 29, 1994 to Calcote, et al.), 5,358,695 (Oct. 25, 1994 to Helble, et al.), and 5,958,361 (Sep. 28, 1999 to Laine, et al.).

Ultrafine particles of metals, metallic compounds, and ceramics can be produced by heating a starting material with a plasma. Saiki, et al. (U.S. Pat. No. 4,812,166, Mar. 14, 1989) disclosed a method that involved vaporizing a starting material by supplying this material into a plurality of direct-current (DC) plasma currents combined at a central axis of a work coil for generating high frequency induction plasma positioned under the DC plasma-generated zone. One major shortcoming of this process is the need to use a complicated configuration of multiple plasmas for heating and vaporizing the incoming material. This process is energy inefficient and difficult to control.

Another example of plasma arc based apparatus is disclosed by Araya, et al. (U.S. Pat. Nos. 4,732,369, Mar. 22, 1988 and 4,610,718, Sep. 9, 1986). The apparatus for producing ultra-fine particles by arc energy comprises a generating chamber for generating ultra-fine particles, an electrode positioned opposite to a base material so as to generate an electric arc, a suction opening for sucking the particles generated in the chamber, a trap for collecting the particles sucked from the suction opening, and a cooler positioned between the suction opening and the trap for cooling the sucked ultra-fine particles. The process involves the utilization of dissociable oxygen in the working gas which tends to cause erosion of the non-consumable tungsten electrode used in the apparatus and generates tungsten impurities in the final product.

Still another example of a plasma arc based process for synthesizing nano particles was disclosed by Parker, et al. (U.S. Pat. Nos. 5,514,349, May 7, 1996 and 5,874,684, Feb. 23, 1999). The system used in this process includes a chamber, a non-consumable cathode shielded against chemical reaction by a working gas (not including an oxidizing gas, but including an inert gas), a consumable anode vaporizable by an arc formed between the cathode and the anode, and a nozzle for injecting at least one of a quench and reaction gas in the boundaries of the arc. This system has several drawbacks. Firstly, the configuration of having a non-consumable electrode and a consumable electrode being paired up to form an arc does not provide efficient vaporization of the consumable electrode. A certain portion of the consumable electrode is just melted and drips down to the bottom of the system, never to have a chance of being vaporized. This dripped material cannot be re-fed to the system and, therefore, ends up being scraped. Second, the configuration does not permit an efficient use of the plasma arc energy with most of the energy being wasted. Third, since the ionic or plasma arc environment is highly erosive to the non-consumable electrode, it is difficult to maintain a stable arc and the operator has to replace the electrode periodically.

Glazunov, et al. (U.S. Pat. No. 3,752,610, Aug. 14, 1973) disclosed a powder-producing device that includes a rotatable, consumable electrode and a non-consumable electrode. In a method proposed by Clark (U.S. Pat. No. 3,887,667, Jun. 3, 1975), an arc is struck between a consumable electrode and a second electrode to produce molten metal which is collected, held and homogenized in a reservoir and subsequently atomized to produce powdered metals. Akers (U.S. Pat. No. 3,975,184, Aug. 17, 1976) developed a method for powder production, which entails striking an electric arc between an electrode and the surface of a pool of molten material. The arc rotates under the influence of a magnetic field to thereby free liquid particles from the surface of the pool. The liquid particles are then quenched to become a solid powder material. Uda, et al. (U.S. Pat. Nos. 4,376,740, Mar. 15, 1983; 4,482,134, Nov. 13, 1984; 4,642,207, Feb. 10, 1987; and 4,889,665, Dec. 26, 1989) taught a process for producing fine particles of a metal or alloy. The process involves contacting a molten metal or alloy with activated hydrogen gas thereby to release fine particles of the metal or alloy. The method disclosed by Ogawa, et al. (U.S. Pat. No. 4,610,857, Sep. 9, 1986) entails injecting a powder feed material into a plasma flame created in a reactive gas atmosphere. The powder injection rate is difficult to maintain and, with a high powder injection rate, a significant portion of the powder does not get vaporized by the plasma flame. Beaty, et al. (U.S. Pat. No. 5,194,128, Mar. 16, 1993) used high-frequency, high-voltage, and high peak-current discharge to disrupt the crystal lattice or micro-grain structure of a metal or inter-metallic compound for producing ultra-fine particles. In short, the above prior art methods have exhibited one or more of the following shortcomings: (1) The powder particles produced tend to be on the micrometer-scaled and particles of 20 nm or smaller are difficult to obtain with most of these prior-art methods; (2) Most of the prior-art systems or apparatus are not energy efficient with most of the plasma arc energy being wasted; (3) Systems or apparatus that involve a non-consumable electrode are unstable and difficult to control due to the arc-induced erosion on the non-consumable electrode; (4) In most cases, the apparatus design is complicated and the required equipment is expensive; and (5) In many cases, the need to have a high vacuum and/or the batch-wise material-feeding mechanism make them non-continuous processes that are not amenable to the mass production of nano-scaled powders.

Accordingly, one object of the present invention is to provide an improved system for producing metal, metal compound and ceramic powder materials at the nanometer-scale.

A specific object of the present invention is to provide a more energy-efficient system for producing nano-scale powder materials.

Another specific object of the present invention is to provide a system for producing nano-scale powder materials at a high throughput rate.

Another object of the present invention is to provide a system for producing ultra fine metal, metal compound, and ceramic powder materials from a wide range of feed materials.

A further object of the present invention is to provide a system for producing a mixture of ultra fine powder materials which are well mixed at a predetermined proportion.

### SUMMARY OF THE INVENTION

One embodiment of the present invention is a system for synthesizing a nano-scaled powder material, including several sub-systems:

(A) a chamber for containing nano-scaled clusters generated from a material selected from the group consisting of a metal, a metal compound, and a ceramic;

(B) a twin-wire electrode device in supplying relation to this chamber for providing nano-scaled clusters therein. This electrode device includes: (i) two wires made up of this material, each having a leading tip and each being continuously or intermittently fed into the chamber in such a fashion that the two leading tips are maintained at a desired separation; and (ii) means for providing electric current and a working gas flow for creating an ionized arc between the two leading tips for melting and/or vaporizing the material to generate nano-scaled clusters;

(C) means for injecting a quench gas and/or a reaction gas into a quenching/reaction zone inside the chamber at a point downstream from arc to convert vapor-state clusters to solid state particles and/or to convert metal clusters into compound or ceramic powder particles; and

(D) means to collect the nano-scaled powder material.

In another embodiment of the invented system, the two wires are made up of two different materials so that a mixture of nano powders can be produced for the purpose of making a composite material.

In a preferred embodiment, the system (for both cases of two wires of the same material and of different materials) as defined above may further include a second plasma arc zone below the ionized arc between the two wire tips to vaporize any un-vaporized material dripped therefrom. In another preferred embodiment, the system may further include a reservoir disposed at the bottom portion of the ionized arc or a distance below the arc in such a fashion that the reservoir can receive or trap any un-vaporized material from the wires and continue to expose the un-vaporized material to the heat energy of the ionized arc to further vaporize at least a portion of the un-vaporized material when present.

The presently invented system is applicable to essentially all metallic materials (including pure metals and metal alloys), metal compounds, and ceramic materials. As used herein, the term “metal” refers to an element of Groups 2 through 13, inclusive, plus selected elements in Groups 14 and 15 of the periodic table. Thus, the term “metal” broadly refers to the following elements:

Group 2 or IIA: beryllium (Be), magnesium (Mg), calcium (Ca), strontium (Sr), barium (Ba), and radium (Ra).

Groups 3-12: transition metals (Groups IIIB, IVB, VB, VIB, VIIB, VIII, IB, and IIB), including scandium (Sc), yttrium (Y), titanium (Ti), zirconium (Zr), hafnium (Hf), vanadium (V), niobium (Nb), tantalum (Ta), chromium (Cr), molybdenum (Mo), tungsten (W), manganese (Mn), technetium (Tc), rhenium (Re), iron (Fe), ruthenium (Ru), osmium (Os). cobalt (Co), rhodium (Rh), iridium (fr), nickel (Ni), palladium (Pd), platinum (Pt), copper (Cu), silver (Ag), gold (Au), zinc (Zn), cadmium (Cd), and mercury (Hg).

Group 13 or IIIA: boron (B), aluminum (Al), gallium (Ga), indium (In), and thallium (TI).

Lanthanides: lanthanum (La), cerium (Ce), praseodymium (Pr), neodymium (Nd), promethium (Pm), samarium (Sm), europium (Eu), gadolinium (Gd), terbium (Th), dysprosium (Dy), holmium (Ho), erbium (Er), thulium (Tm), ytterbium (Yb), and lutetium (Lu).

Group 14 or IVA: germanium (Ge), tin (Sn), and lead (Pb).

Group 15 or VA: antimony (Sn) and bismuth (Bi).

When high service temperatures are not required, the component metal element (in an alloy, compound, or ceramic) may be selected from the low melting point group consisting of bismuth, cadmium, cesium, gallium, indium, lead, lithium, rubidium, selenium, tellurium, tin, and zinc, etc. When a high service temperature is required, a metallic element may be selected from the high-melting refractory group consisting of tungsten, molybdenum, tantalum, hafnium and niobium. Other metals with intermediate melting points such as copper, zinc, aluminum, iron, nickel and cobalt may also be selected.

Preferably the quench/reactive gas includes a gas selected from the group consisting of argon, helium, hydrogen, oxygen, carbon, nitrogen, chlorine, fluorine, boron, iodine, sulfur, phosphorus, arsenic, selenium, tellurium and combinations thereof. Argon and helium are noble gases and can be used to quench the nano clusters in the vapor state to produce solid powders (without involving any chemical reaction). Some gases may be selected to passivate the clusters to produce un-agglomerated fine metal or ceramic powders; e.g., Se vapor may be used to passivate the surface of telluride clusters. The other gases may be used to react with the metal clusters to form nanometer-scale compound or ceramic powders of hydride, oxide, carbide, nitride, chloride, fluoride, boride, iodide, sulfide, phosphide, arsenide, selenide, and telluride, and combinations thereof.

Specifically, if the quench/reactive gas contains a reactive gas (e.g., oxygen), this reactive gas will rapidly react with the metal clusters to form nanometer-sized ceramic particles (e.g., oxides). If the quench/reactive gas contains a mixture of two or more reactive gases (e.g., oxygen and nitrogen), the resulting product will contain a mixture of two compounds or ceramics (e.g., oxide and nitride). If the metal wire is a metal alloy or mixture (e.g., containing both indium and tin elements) and the reactive gas is oxygen, the resulting product will contain ultrafine indium-tin oxide particles.

The reactive gas can undergo a reaction with vaporized metal clusters at high temperatures in a substantially spontaneous and self-sustaining fashion. The reaction heat released is effectively used to sustain the reactions in an already high temperature environment.

The system preferably further includes a means of collecting the cooled powder particles in a powder collector system composed of at least one cyclone and a device for separating exhaust gases from solid particles.

Advantages of the present invention may be summarized as follows:

1. A wide variety of nano-scaled metal, metal compound, and ceramic particles can be readily produced using the present system. The metallic element(s) in a starting feed material can be selected from any element in the periodic table that is considered to be metallic. The corresponding partner gas reactants may be selected from, for instance, hydrogen, oxygen, carbon, nitrogen, chlorine, fluorine, boron, and sulfur to form respectively metal hydrides, oxides, carbides, nitrides, chlorides, fluorides, borides, and sulfides and combinations thereof. No known prior-art technique is so versatile in terms of readily producing so many different types of nano-scaled metallic, compound, and ceramic powders at a high production rate.

2. The wire material may contain an alloy of two or more elements which are uniformly dispersed. When broken up into nano-sized clusters, these elements remain uniformly dispersed and are capable of reacting with selected reactant species to form uniformly mixed compound or ceramic powder particles. No post-fabrication mixing is necessary for the purpose of making a composite material.

3. The system allows a spontaneous reaction to proceed between a metallic element and a reactant gas such as oxygen. The reaction heat released is automatically used to maintain the reacting medium in a sufficiently high temperature so that the reaction can be self-sustaining until completion for the purpose of producing a compound or ceramic material. The reaction between a metal and certain gas reactant (e.g., oxygen) can rapidly produce a great amount of heat energy, which can be used to drive other reactions that occur concurrently or subsequently when other reactant elements (e.g., carbon or nitrogen) are introduced.

4. The system permits an uninterrupted feed of wires or rods, which can be of great length.

This feature makes the process fast and effective and now makes it possible to mass produce nano-sized metal, compound, and ceramic powders cost-effectively.

5. The system is simple and easy to operate. It does not require the utilization of heavy and expensive equipment. The over-all product costs are very low.

6. The present system fundamentally differs from the apparatus used in U.S. Pat. No. 4,610,718 (Sep. 9, 1986 to Araya, et al.), which also makes use of two consumable electrodes. As indicated earlier, the process of Araya, et al. involves the utilization of dissociable oxygen in the working gas which tends to cause erosion of the non-consumable tungsten electrode used in the apparatus and generates tungsten impurities in the final product. The Araya's apparatus design does not allow an efficient use of the arc energy and the arc does not fully vaporize the feed material, leaving behind a significant portion of the feed material (consumable electrode material) unconverted. The apparatus of Araya, et al. is not equipped with a quench gas for preventing particle agglomeration, nor is it supplied with a reactive gas to react with a metal element in the electrode for producing a compound or ceramic material through a self-propagating reaction until completion.

7. The present system has several advantages over the system of Parker, et al. (U.S. Pat. No. 5,514,349, May 7, 1996). In Parker's system, the configuration of having a non-consumable electrode and a consumable electrode being paired up to form an arc does not provide efficient vaporization of the consumable electrode. A significant portion of the consumable electrode is just melted and drips down to the surface of a supporting substrate to form a “weld pool” thereon. The consumable electrode (typically a thick rod) cannot be advanced (fed) into the arc zone until most of the material in this pool of molten metal is vaporized. This bottleneck severely limits the rod-feeding rate and the over-all powder production rate with this system is very low. Further, since the ionic or plasma arc environment is highly erosive to the non-consumable electrode in the Parker's system, it is difficult to maintain a stable arc and the operator has to replace the electrode periodically. In contrast, in our present invention, the two wires can be continuously fed into the vaporization chamber with the leading tips of the wires continuously vaporized at a high feeding rate for producing nano powders continuously without interruption and at a high throughput rate.

### BRIEF DESCRIPTION OF THE DRAWINGS

FIG. 1(a) shows the schematic of a preferred embodiment of a system for producing nanometer-sized metallic, metal compound, and ceramic powders and (b) the same system with a powder collector-separator system.

FIG. 2(a) the same system as in FIG. 1a, but with a melt reservoir 85 to receive or trap any unvaporized melt that drips out of the arc 80 and (b) the same system as in FIG. 1a, but with an additional plasma arc zone to vaporize any melt that drips out of the arc 80.

FIG. 3(a) schematically shows a twin-wire arc thermal spray gun that can be used as a nano cluster generating device in the invented system and (b) another twin-wire arc thermal spray gun.

### DETAILED DESCRIPTION OF PREFERRED EMBODIMENTS

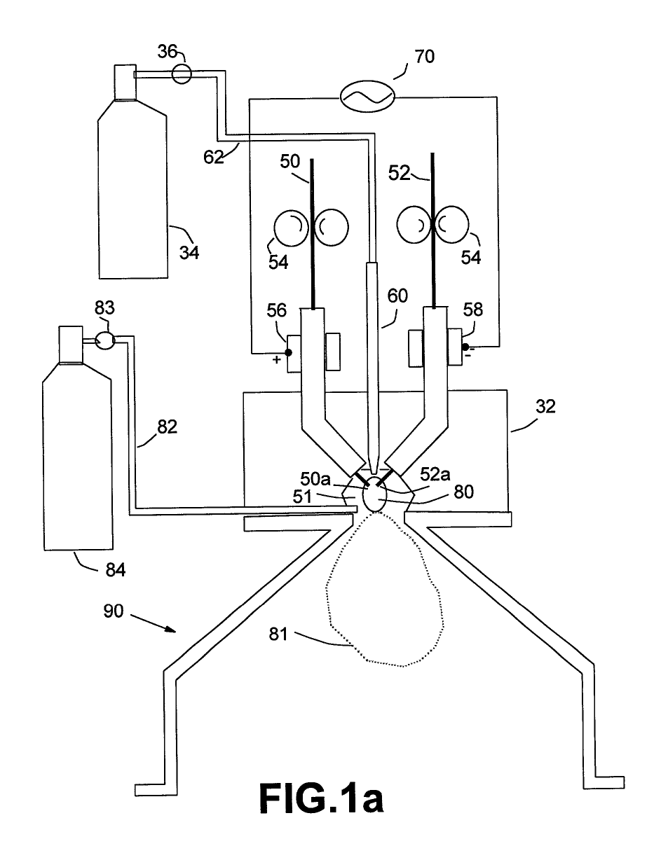

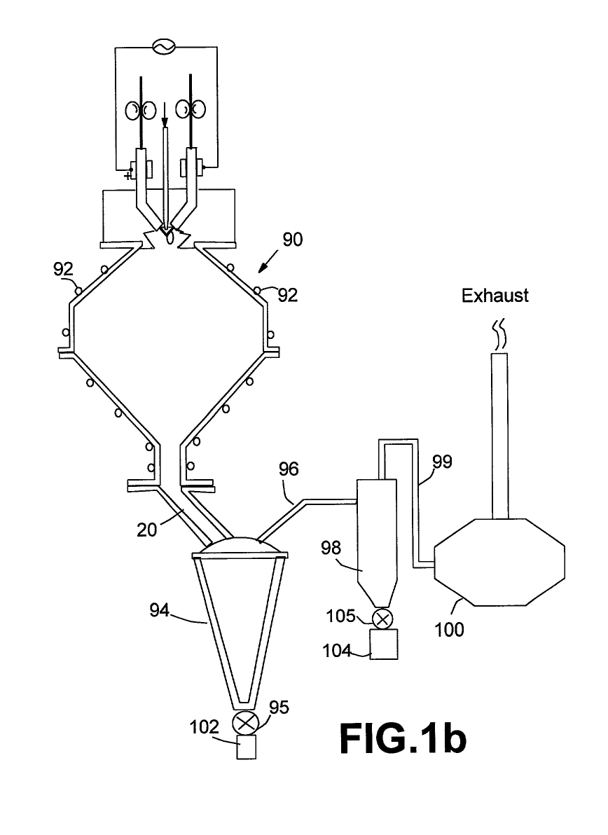

FIGS. 1a and 1b schematically show a nano powder production system, in accordance with a preferred embodiment of the present invention. This system includes four major functional component sub-systems:

(A) a chamber (e.g., 90) for receiving nano-scaled clusters generated by (B);

(B) a twin-wire electrode device in supplying relation to the chamber. This electrode device includes: (i) two wires 50,52 made up of a desired material, each wire having a leading tip 50a or 52a and each wire being continuously or intermittently fed (e.g., through rotating rollers 54) into the chamber in such a fashion that the two leading tips 50a ,52a are maintained at a desired separation; and (ii) means for providing electric current and a working gas flow (e.g., from a gas bottle 34, through a control valve 36, and pipe means 62,60) for creating an ionized arc 80 between the two leading tips for melting and/or vaporizing the material at the tips to generate nano-scaled clusters 81 in the chamber;

(C) means (e.g., from a gas bottle 84, through a valve 83 and pipe 82) for injecting a quench gas and/or a reaction gas into a quenching/reaction zone inside the chamber at a point inside the tail end of the arc or downstream from the arc to produce nano-scaled powder particles (e.g., by quenching the vapor clusters to become solid particles or by allowing the reaction gas to react with the vapor clusters to produce compound or ceramic particles); and

(D) means (e.g., including a cyclone or powder classifier, from 94 to 105 in FIG. 1b) to collect the nano-scaled powder material.

For the purpose of clearly defining the claims, the word “wire” means a wire of any practical diameter, e.g., from several microns (a thin wire or fiber) to several centimeters (a long, thick rod). A wire can be supplied from a spool, which could provide an uninterrupted supply of a wire as long as several miles. This is a very advantageous feature, which makes the related powder production process a continuous one.

In a preferred embodiment of the presently invented system, as indicated in FIG. 1a, the twin-wire electrode device basically contains a twin-wire electric arc spray nozzle, which is mainly comprised of an electrically insulating block 32, two feed wires 50, 52, a feeding mechanism (e.g., including motorized rollers 54), and a working gas passage or pipe means 60 which directs the flow of a working gas from the supply 34 into a cell 51 near the two respective leading tips 50a,52a of the wires. The two metal wires 50,52 are supplied with a DC voltage or current (one “+” and the other “−”) or a pulsed power through the electrodes 56,58 to form an arc 80 in an arc cell 51. This arc 80, being at an ultra-high temperature (up to 6,000° C.), functions to melt and vaporize the wire tips to form nano-scaled vapor clusters, typically on a continuous basis. The stream of working gas passes through the passage means 60 into the arc chamber 51 not only to help generate and maintain the arc 80 but also to carry the vapor clusters downward toward the receiving chamber 90. Preferably the working gas flows vertically downward to help carry the nano clusters into the receiving chamber, and possibly through a separate plasma arc zone to vaporize any un-vaporized material.

The ultra-fine clusters 81 thus generated could remain in a vapor or liquid state in which individual clusters could aggregate or stick together if left alone. It is therefore desirable to employ a solid powder formation facilitator means to help the clusters solidify and remain separated from one another. The powder facilitator means may include blowing a quenching gas (e.g., cool, inert gas) through a gas regulator (flow rate control valve) 83 and pipe means 82 to impinge upon the clusters immediately after the clusters are formed. The gas flow rate can be varied to adjust the cluster sizes. Additional cooling means may include copper or steel tubing 92 or channels, containing cooling water, that are jacketed around the chamber 90 to facilitate solidification of the clusters therein for forming solid powders. These powders, along with the residual working gas and cooling gas are transferred through a conduit 20 to a powder collector/separator system (e.g., schematically shown in the lower portion of FIG. 1b)

It may be noted that, if the gas coming from the supplier 84 contains a reactive gas such as oxygen, the metal vapor clusters or highly super-heated metal melt droplets in the ionized arc or near the bottom of the ionized arc can quickly react with oxygen to form nano-sized oxide particles. Since the oxidation of a metal is normally a highly exothermic process, a great amount of reaction heat is released which can in turn be used to activate, maintain, or accelerate the oxidation reactions of other metal clusters or droplets. Such a self-sustaining reaction rapidly converts the liquid metal droplets or vapor clusters into nano-scaled metal compound or ceramic particles. Other reactive gases that can be selected include hydrogen, carbon-containing gas (e.g., CO), nitrogen, chlorine, fluorine, boron, iodine, sulfur, phosphorus, arsenic, selenium, tellurium and combinations thereof.

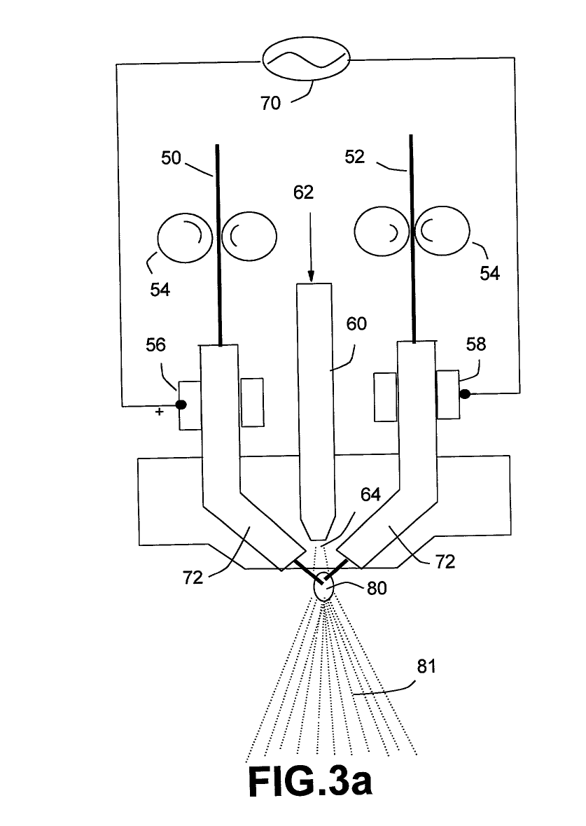

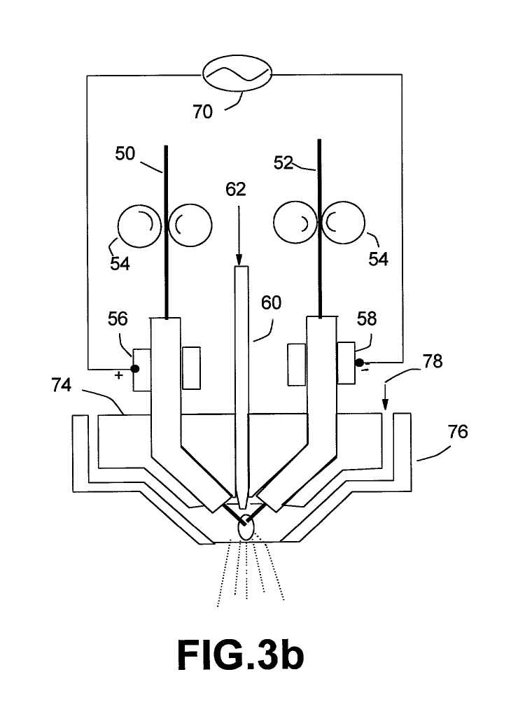

The twin-wire arc spray nozzle, originally developed for use in a spray coating process, can be adapted for providing a continuous stream of vapor clusters flowing into the receiving chamber 90. This low-cost device is capable of readily melting and vaporizing the metal wire to a temperature as high as 6,000° C., and is further illustrated in FIGS. 3a and 3b.

Schematically shown in FIG. 3a is an open-style twin-wire arc spray nozzle. Two metal wires 50,52 are driven by powered rollers 54 to come in physical contact with two respective conductive jackets 72 which are supplied with “+” and “−” voltage or pulsed power through electrically conductive blocks 56 and 58, respectively. The voltage polarity may be reversed; i.e., “−” and “+” instead of “+” and “−”, The voltages come from a DC or pulsed power source 70. The lower ends of the two wires approach each other at an angle of approximately 30-60°. The two ends are brought to contact each other for a very brief period of time. Such a “short circuit” contact creates an ultra-high temperature due to a high current density, leading to the formation of an ionized arc 80. A stable arc can be maintained provided that the current is constantly supplied, a certain level of gas pressure is maintained, and the wires are fed at a constant or pulsating speed. A stream 64 of compressed air, introduced through a gas regulator 36 and gas passage 60,62 from a gas source (e.g., a compressed air bottle 34 in FIG. 1a), also serves to carry the vaporized clusters downward into the receiving chamber.

An improved version of the twin-wire device is a closed-style arc spray nozzle as schematically shown in FIG. 3b. In this spray arc nozzle, the arc zone is enclosed in a block 74 by an air cap 76 and additional compressed gas or air (referred to as the secondary gas) is introduced (e.g., from 78) into the arc zone to compress the arc. The increased arc zone pressure effectively increases the arc temperature, thereby promoting the more efficient vaporization, resulting in much finer vapor clusters. Twin-arc spray nozzles have been advanced to the extent that they provide reliable and stable ultra-high temperature arcs. These low cost devices are available from several commercial sources. Examples of these devices can be found in the following patents: U.S. Pat. Nos. 4,095,081 (Jun. 13, 1978 to S. J. Ashman), 4,668,852 (May 26, 1987 to T. J. Fox, et al.), and 5,964,405 (Oct. 12, 1999 to R. Benary, et al.).

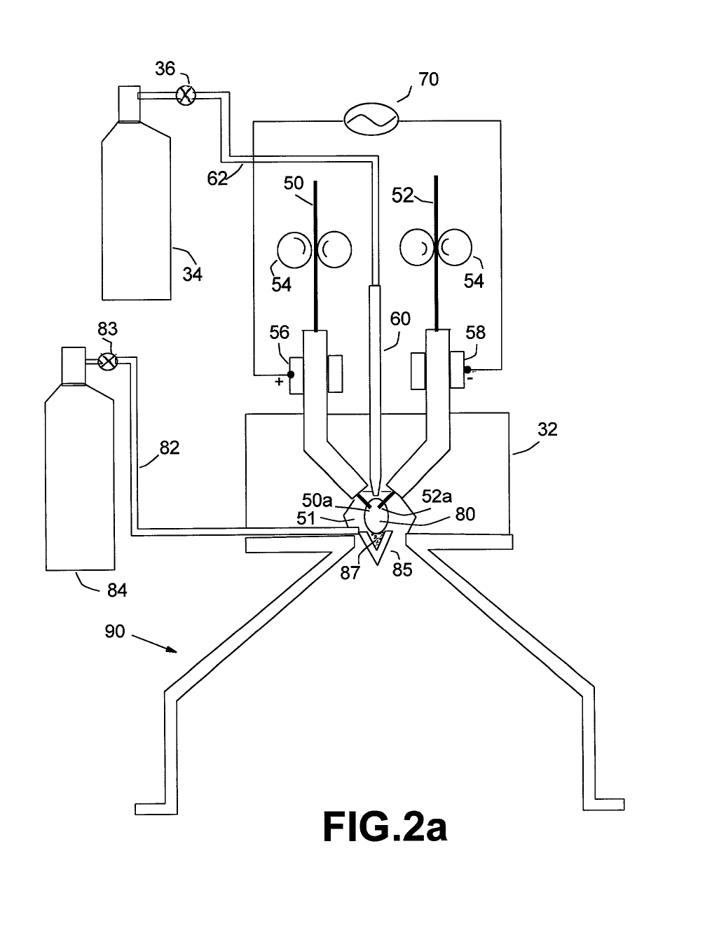

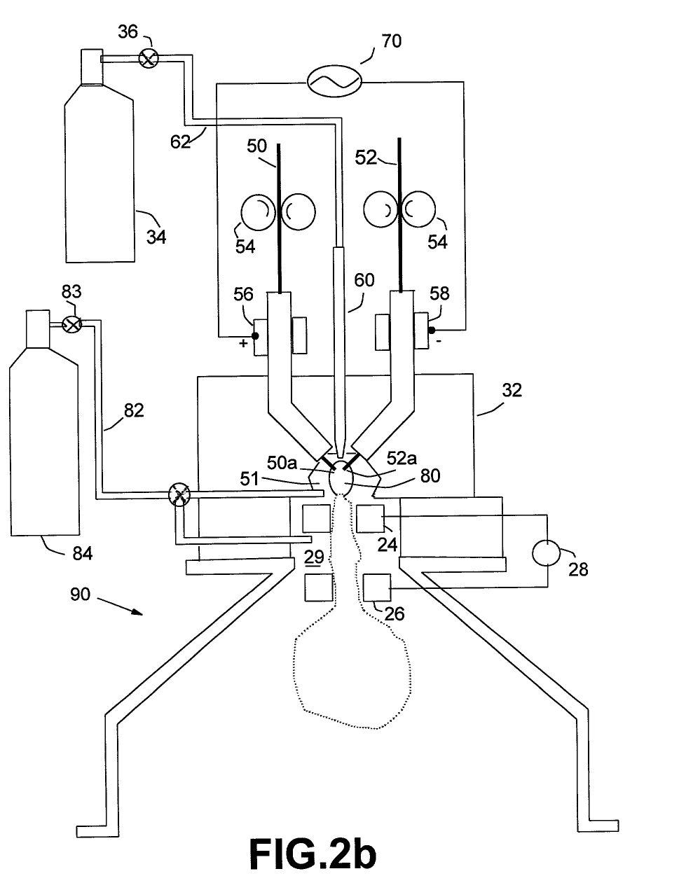

For some materials with a relatively high vaporization temperature or boiling point, and if the working gas flow rate is relatively high, a certain amount of the wire tip material may not be exposed to the high temperature environment for a sufficiently long duration of time needed for a full vaporization. As a consequence, small melt droplets may drip downward toward the receiving chamber. There are two ways to overcome this rare difficulty. One is to make use of a reservoir (85 in FIG. 2a) positioned just below the arc 80 to trap or accommodate the unvaporized material 87, which will continue to receive heat from the arc 80 for further vaporization. Another is to use a plasma arc device (e.g., constituted by 24, 26, 28 in FIG. 2b) to generate a plasma arc zone 29 through which the un-vaporized melt droplets dripped out of the ionized arc 80 will have another chance to get vaporized. The creation of a plasma arc zone is well-known in the art. The ultra-high temperature in the plasma arc (up to as high as 32,000 °K.) rapidly vaporizes the melt droplets that pass through the plasma arc zone.

The receiving chamber 90 is preferably further connected to a powder collector and separator system, as shown in FIG. 1b. As an example, the chamber 90 is connected to a collector chamber 94, commonly referred to as an expansion chamber. The lower part of this expansion chamber 94 has an outlet being communicated to a removable powder collection container 102 through a valve 95. The valve 95 is open during production of the clusters so that powder separated and collected by the chamber 94 can be received and collected in the container 102. The expansion chamber may be allowed to communicate through conduits 96,99 with a series of cyclones (only one cyclone 98 being shown) and a filter device (e.g., including a wet scrubber 100). The finely divided metallic, compound, or ceramic powder product is suspended in reaction product gases as well as excess working gas, hereinafter collectively referred to as product gases or product fluids. The product fluids are removed from the chamber 90 through conduit 96,99 and introduced into cyclones 98 and filer/separator device, in order to separate the solid powder from the product fluids. The nano-sized particles are formed completely in the chamber and since the cluster effluent is rapidly cooled to below the powder forming temperatures substantially immediately, little or no additional ceramic or metal solid formation or individual particle growth occurs outside the chamber.

A cyclone 98 is normally cooled (e.g., externally water chilled) to cool the powder product. As the product fluids travel through cyclones 98, the powder drops into receiver 104 with the valve 105 being open, while gaseous effluent leaves cyclone 98 through conduit 99 into a solid separation chamber (e.g., a wet scrubber 100). The wet scrubber can be a caustic water scrubber, containing packing of balls, saddles, etc. for greater contact. The scrubber separates the fine solid particles from the gas stream and possibly neutralizes acidic species therein before the gas is discharged to the atmosphere or to a flue. Any additional filtering device such as a bag filter, electrostatic precipitator or other equivalent means for separating suspended solids from a gas may be used. While only one cyclone and one solid separator are shown, more than two can be used. Alternatively, other types of powder collector and/or separator devices may be used. Solid powder collector and solid-gas separator systems are widely available in industry.

The starting material can be an alloy of two or more elements which are uniformly dispersed. When broken up into nano-sized clusters, these elements remain uniformly dispersed and are capable of reacting with selected reactant species to form uniformly mixed ceramic powder particles. No post-fabrication mixing is necessary for the preparation of a hybrid or composite material.

The reactive gas can contain vapor, liquid, or solid particles suspended in a carrier gas. A solid reactant in fine powder form requires a carrier gas to carry it into the arc cell. An example is fine carbon powders suspended in either an inert gas (e.g., helium) or reactive gas (e.g., oxygen), depending upon the types of intended ceramic powders to be produced. In the former example, a metal carbide will be produced. The helium gas is used only as a carrier medium. In the latter example, oxygen gas is used to react with metal vapor clusters. If more than two reactant elements are used (e.g., carbon particles suspended in oxygen gas, or a mixture of CO and O₂), more complicated reactions can occur. Under favorable conditions, oxidation of a metal occurs, resulting in the release of a great amount of heat, which can be used to promote the reaction between a metal element (if still available) and carbon. The supply of a vaporized metal element and a mixture of two reactant gases can lead to the formation of a mixture of two compounds or ceramics. If the production of a uniform mixture of ceramics from a metallic alloy is desired, this alloy can be introduced as two wires of identical alloy composition into the twin-wire arc spray nozzle. Alternatively, the two wires may be made up of different metal compositions. For example, a technologically important oxide mixture is indium-tin oxides. This product can be used in a flat panel display technology. In one instance, a tin wire and an indium wire were fed into an arc sprayer nozzle and vaporized. An oxygen flow at a rate of 200 scfm under a gas pressure of approximately 200 psi was used to mix and react with the mixture of metal vapor clusters. Ultra-fine indium-tin oxide particles with an average diameter of 12 nm were obtained. A production rate of 20 kilograms per hour was achieved with a lab-scale apparatus.

What is claimed:

1. A system for synthesizing a nano-scaled powder material, comprising:
(A) a chamber for receiving nano-scaled clusters generated from a material selected from the group consisting of a metal, a metal compound, and a ceramic;
(B) a twin-wire electrode device in supplying relation to said chamber for supplying nano-scaled clusters therein, said electrode device comprising
(i) two wires made up of said material, with each wire having a leading tip which is continuously or intermittently fed into said chamber in such a fashion that the two leading tips are maintained at a desired separation; and
(ii) means for providing electric currents and a working gas flow for creating an ionized arc between the two leading tips for melting and/or vaporizing said material to generate said nano-scaled clusters;
(C) means for injecting a quench gas and/or a reaction gas into a quenching/reaction zone inside said chamber at a point inside said arc or downstream from said arc to facilitate the formation of nano-scaled powder particles; and
(D) means to collect the nano-scaled powder material.

2. The system as defined in claim 1, further including a second plasma arc zone below said ionized arc to vaporize any un-vaporized material dripped therefrom.

3. The system as defined in claim 1, further including a reservoir disposed at the bottom portion of said arc or a distance below said arc in such a fashion that said reservoir receives any unvaporized material from the wires and exposes said un-vaporized material to the heat energy of said arc to further vaporize at least a portion of said un-vaporized material.

4. A system for synthesizing a nano-scaled powder material mixture, comprising:
(A) a chamber for receiving nano-scaled clusters generated from two materials of different compositions with each material selected from the group consisting of a metal, a metal compound, and a ceramic;
(B) a twin-wire electrode device in supplying relation to said chamber for providing nano-scaled clusters therein, said electrode device comprising
(i) two wires respectively made up of said two different materials, each wire having a leading tip and each wire being continuously or intermittently fed into said chamber in such a fashion that the two leading tips are maintained at a desired separation; and
(ii) means for providing electric currents and a working gas flow for creating an ionized arc between the two leading tips for melting and/or vaporizing said materials to generate said nano-scaled clusters;
(C) means for injecting a quench gas and/or a reaction gas into a quenching/reaction zone inside said chamber at a point inside said arc or downstream from said arc to produce a nano-scaled powder particle mixture; and
(D) means to collect the nano-scaled powder material mixture.

5. The system as defined in claim 1, 2, 3, or 4 further including wire feed and control means to regulate the feed rates of said two wires.

6. The system as defined in claim 1, 2, 3, or 4 wherein said means for providing electric currents comprises an electric power supply selected from the group consisting of a high-voltage source, a high-current source, a pulsed power source, and combinations thereof.

7. The system as defined in claim 1, 2, 3, or 4 further including means for controlling the rate of flow of the quench gas and/or the reaction gas, thereby enabling change of particle size of the nano-scaled powder material.

8. The system as defined in claim 1, 2, 3, or 4 wherein said reaction gas is selected from the group consisting of nitrogen, phosphorus, arsenic, oxygen, sulfur, selenium, tellurium, fluorine, chlorine, bromine, iodine, a carbon-containing gas, and mixtures thereof.

9. The system as defined in claim 1, 2, 3, or 4 wherein said working gas is selected from the group consisting of nitrogen, hydrogen, noble gases and mixtures thereof.

10. The system as defined in claim 1, 2, 3, or 4 wherein said means to collect the nano-scaled powder material comprises a cyclonic mixer for turbulently mixing said nano clusters produced in said reaction zone for cooling said nano clusters to become a solid nano powder and means for filtering the nano powder material from gas flowing through the system.

11. The system as defined claim 1, 2, 3, or 4 wherein said means for injecting comprises a concentric gas injection device adjustably positioned along the location of said ionized arc.

12. The system as defined in claim 1, 2, 3, or 4 wherein said quench gas is selected from the group consisting of helium, argon, air, water vapor, carbon monoxide, carbon dioxide, hydrogen and combinations thereof.

13. The system as defined in claim 1, 2, 3, or 4 further including means for providing dissociable inert gas mixable with said working gas, the dissociable inert gas increasing the temperature gradient in said ionized arc.

14. The system as defined in claim 1, 2, 3, or 4 further including means separate from said means for injecting a quench/reaction gas, said separate means for injecting a cooling gas into said nano clusters, thereby minimizing agglomeration of the nano powder material or mixture.

15. The system as defined in claim 1, 2, 3, or 4 wherein said working gas flow direction is approximately vertical.
